(19) United States
(12) Patent Application Publication
(10) Pub. No.: US 2026/0234340 A1
(43) Pub. Date: Aug. 13, 2026

(54) SYNTHESIS OF FLUORO-SILICON POLYMER

(71) Applicants: Dow Sillicones Corporation, Midland, MI (US); Dow Global Technologies LLC, Midland, MI (US)

(72) Inventors: Aiping Wang, Shanghai (CN); Qing Zhu, Shanghai (CN); Pranav Karanjkar; Reza Panah, Midland, MI (US); Chengyuan Sun; Xiaocong Xu; Shuhua Zhang, Shanghai (CN)

(21) Appl. No.: 19/472,776

(22) PCT Filed: May 10, 2023
(86) PCT No.: PCT/CN2023/093155

§ 371 Date: Oct. 6, 2025

(51) Int. Cl. C08G 77/24; C08G 77/08; C08G 77/34

(52) U.S. Cl. CPC C08G 77/24; C08G 77/08; C08G 77/34

(57) ABSTRACT

A process for preparing a fuoro-silicon polymer includes the following steps: (a) combining octamethylcyclotetrasiloxane, polydimethylsiloxane, tetrakis (vinyldimethylsiloxy) silane, potassium silanolate siloxane; and optionally, trifluoropropylmethylcyclotrisiloxane; (b) adding to the mixture polydimethylaminophosphazenium hydroxide to form a reaction mixture and heating the reaction mixture to a temperature in a range of 140 to 150 degrees Celsius; (c) if trifluoropropylmethylcyclotrisiloxane was not added in step (a), adding it dropwise to the reaction mixture while the reaction mixture is at a temperature in a range of 110 to 150 degrees Celsius; (d) maintaining the reaction mixture at a temperature in a range of 140 to 150 degrees Celsius as the viscosity of the reaction mixture increases and for an equilibrium time in a range of one to 4 additional hours after the reaction mixture viscosity stabilizes; and terminating the reaction by adding a neutralizer and then stripping volatiles to obtain product.

### FIELD

The present invention relates to a process for preparing a fluoro-silicon polymer.

### INTRODUCTION

Release coating compositions are useful in many applications including treating backing sheets for pressure sensitive adhesives to enable the pressure sensitive adhesive to detach from the backing sheet. Fluoro-silicon (F—Si) release coatings, which are release coatings comprising fluorine and silicon atoms in the coating composition, are particularly popular release coatings. Typically, F—Si release coatings comprise siloxane polymers with fluorine bound to the siloxane polymer backbone, usually indirectly through pendant groups.

F—Si release coatings are useful in both high end and low-mid end applications, with the primary difference being in the release performance of the coating. High end applications require lower adhesion/greater release capability and often utilize more expensive components. Low-mid end applications have less demanding performance criteria and demand lower cost compositions. A challenge is to identify F—Si polymers suitable for release coating applications but that are also low cost to produce so they are suitable for use in low-mid end release coating applications.

F—Si release coatings are typically curable compositions that cure to form a polymeric coating with desirable release properties. Generally, a release coating comprises a F—Si polymer with polymerizable functional groups, a catalyst to facilitate curing, an inhibitor to enhance storage stability, a crosslinker to participate in curing and provide mechanical strength, a release modifier and processing aides and additives. The F—Si polymer is one of the more expensive components of the composition. Therefore, it is desirable to identify ways to reduce the cost of F—Si polymers for such compositions in order to make them desirable in low-mid end release coating applications.

One F—Si polymer (“Target F—Si Polymer”) currently useful in both solvent-free and solvent-containing F—Si release coatings applications has the following chemical composition: Si [OR′]₄, where each R′ is independently selected from vinyl groups and monovalent polysiloxanes comprising (CH₃)₃SiO_{1/2}, (CH₃)₂SiO_{2/2}, and (CH₃) R″ SiO_{2/2} siloxane units where R″ is-CH₂CH₂CF₃ and wherein the Target F—Si Polymer has a weight-average molecular weight in a range of 10,000 to 20,000 grams per mole (g/mol). Generally, three or even all four of the R′ groups are selected from the noted polysiloxanes in the Target F—Si Polymer. There is room to improve over current methods for making the Target F—Si Polymer in order to reduce its cost and make it more suitable for low-mid end release coating applications.

### BRIEF SUMMARY OF THE INVENTION

The current process for making the Target F—Si Polymer (“Current Process”) requires the following five steps:
(i) combining octamethylcyclotetrasiloxane, polydimethylsiloxane, trifluoropropylmethylcyclotrisiloxane and tetrakis (vinyldimethylsiloxy) silane together and mixing at 40 degrees Celsius (° C.);
(ii) adding potassium silanolate siloxane and heating to 100° C. for 30 minutes;
(iii) adding polydimethylaminophosphazenium hydroxide at 100° C. and allowing the mixture to warm by exotherm;
(iv) when the temperature reaches 145° C., allowing the viscosity of the reaction mixture to increase and then stabilize and then remain at 145° C. for 4 hours after the viscosity of the reaction mixture has ceased to increase; and
(ν) neutralizing the reaction mixture and stripping volatiles away to obtain the Target F—Si Polymer.

The current process is characterized by an equilibrium time that typically is approximately four hours and by having a long phase during the reaction where gel forms and then eventually dissipates (“gel phase”). Long equilibrium times are undesirable for cost of manufacture considerations. Gel phase is undesirable during the reaction because it hinders mixing and reactant mobility.

The present invention provides a process for preparing the Target F—Si Polymer that provides one or more improvement over the current process for preparing the Target F—Si Polymer. The present invention provides one or a combination of more than one of the following improvements over the current process for making the Target F—Si Polymer: (a) a reduction in required process steps; (b) a reduction in equilibrium time; (c) a reduction or elimination of gel formed during the process of making the Target F—Si Polymer; and (d) an increase in yield of Target F—Si Polymer.

In a first aspect, the present invention is a process for preparing a F—Si polymer where the process comprises the following steps: (a) combining octamethylcyclotetrasiloxane, polydimethylsiloxane, tetrakis (vinyldimethylsiloxy) silane, potassium silanolate siloxane; and optionally, trifluoropropylmethylcyclotrisiloxane; (b) adding to the mixture polydimethylaminophosphazenium hydroxide to form a reaction mixture and heating the reaction mixture to a temperature in a range of 140 to 150 degrees Celsius; (c) if trifluoropropylmethylcyclotrisiloxane was not added in step (a), adding it dropwise to the reaction mixture while the reaction mixture is at a temperature in a range of 110 to 150 degrees Celsius until the trifluoropropylmethylcyclotrisiloxane ceases to be consumed or until a desired amount has been added; (d) maintaining the reaction mixture at a temperature in a range of 140 to 150 degrees Celsius as the viscosity of the reaction mixture increases and for an equilibrium time in a range of one to 4 additional hours after the reaction mixture viscosity stabilizes; and terminating the reaction by adding a neutralizer and then stripping volatiles to obtain product.

The present invention is useful for preparing Target F—Si Polymer for use in release coating compositions.

### BRIEF DESCRIPTION OF THE DRAWINGS

FIG. 1 (a) and FIG. 1 (b) present ²⁹NMR spectra of the product of Examples 1-3 and Comparative Example A (Current Process) indicating that the product has the structure of the Target F—Si Polymer and the similarity of the products.

FIG. 2 presents Raman spectra for the products of Comparative Example A and Examples 1-3 showing they produced the same product.

FIG. 3 presents the Raman spectral peak height ratios for key reactants and product as a function of reaction time during the process for Comparative Example A showing the progress of the reaction by Raman spectroscopy.

FIG. 4 presents the Raman spectral peak height ratios for key reactants and product as a function of reaction time during the process for Example 1 showing the progress of the reaction by Raman spectroscopy.

FIG. 5 presents the Raman spectral peak height ratios for key reactants and product as a function of reaction time during the process for Example 2 showing the progress of the reaction by Raman spectroscopy.

### DETAILED DESCRIPTION

“Multiple” means two or more. “And/or” means “and, or as an alternative”. All ranges include endpoints unless otherwise indicated. Products identified by their tradename refer to the compositions available under those tradenames on the priority date of this document.

“Molecular weight” refers to weight-average molecular weight unless otherwise stated. Determine molecular weight by gel permeation chromatography using polystyrene standards. Use a Waters 2695 Separation Module equipped with a vacuum degasser and a Waters 2414 refractive index detector. Conduct separation with three Styragel HR columns (300 millimeters (mm)×7.8 mm; molecular weight separation range of 100 to 4,000,000), preceded by a Styragel guard column (30 mm×4.6 mm). Conduct analyses using certified grade toluene flowing at 1.0 milliliter per minute as the eluent and a column and detector temperature of 45 degrees Celsius (° C.). Use 0.5 weight/volume samples by weighing approximately 0.025 grams (g) of neat sample into a 12 milliliter glass vial and diluting with approximately 5 milliliters of toluene. Transfer the sample solution to a glass autosampler vial after centrifuging or filtering through a 0.45 micrometers polytetrafluoroethylene filter. Use an injection volume of 100 microliters and collect data for 38 minutes. Perform data collection and analyses using Waters Empower GPC software. Molecular weight values are averages determined relative to a calibration curve (3rd order) created using polystyrene standards covering the molecular weight range of 370 to 1,270,000.

Unless stated otherwise, determine viscosity values for polysiloxanes using a glass capillary viscometer according to ASTM method D-445, IP 71. Use a constant temperature bath of 25° C.+/−0.2° C. and a Cannon Fenski viscometer. Load sample into a tube of the viscometer and place a tube of the viscometer in the water bath to equilibrate it and the sample to temperature for at least 15 minutes prior to testing. Adjust the sample head level to a point about 5 millimeters (mm) above the first timing mark. Allow the sample to flow freely. Start a timer as the meniscus of the sample passes the first timing mark. Stop the timer as the meniscus passes the second timing mark. Record the time to the nearest 0.1 second. Repeat the test without refilling the tube. Refill the tube and repeat the test if the two times do not agree within 0.2 seconds for times under 200 seconds (or are not within 0.2% of one another if over 200 seconds). Use an average of the two values to calculate viscosity.

The present invention is a process for preparing a fluoro-silicon polymer, especially the Target F—Si Polymer. The Target F—Si Polymer is a siloxane polymer that has the following chemical composition: Si [OR′]₄, where each R′ is selected from vinyl groups and polysiloxanes comprising, or consisting of, (CH₃)₃SiO_{1/2}, (CH₃)₂SiO_{2/2}, and (CH₃) R″SiO_{2/2} siloxane units where R″ is-CH₂CH₂CF₃ and wherein the Target F—Si Polymer has a weight-average molecular weight in a range of 10,000 to 20,000 g/mol. Generally, three and preferably all four of the R′ groups are all selected from the noted polysiloxanes comprising or consisting of (CH₃)₃SiO_{1/2}, (CH₃)₂SiO_{2/2}, and (CH₃) R″ SiO_{2/22} siloxane units.

In the broadest scope, the present process comprises the following steps:
(a) combining together the following components to form a mixture: octamethylcyclotetrasiloxane (“D4”); polydimethylsiloxane tetrakis (vinyldimethylsiloxy) silane; potassium silanolate siloxane; and optionally, trifluoropropylmethylcyclotrisiloxane;
(b) adding to the mixture polydimethylaminophosphazenium hydroxide (“SPARC base”) to form a reaction mixture and heating the reaction mixture to a temperature in a range of 110 to 150° C., preferably in a range of 140 to 150° C., more preferably in a range of 145 to 150° C.;
(c) if trifluoropropylmethylcyclotrisiloxane was not added in step (a), adding it dropwise to the reaction mixture while the reaction mixture is at a temperature in a range of 110 to 150° C., preferably in a range of 140 to 150° C., and more preferably in a range of 145 to 150° C. until trifluoropropylmethylcyclotrisiloxane ceases to be consumed or until a desired amount has been added;
(d) maintaining the reaction mixture at a temperature in a range of 140 to 150° C., preferably in a range of 145 to 150° C. as the viscosity of the reaction mixture increases, and then for an equilibrium time of one hour or more, optionally two hours or more, three hours or more while at the same time 4 hours or less, preferably 3 hours or less, 2 hours or less, or even one hour after the reaction mixture viscosity stabilizes; and
(e) terminating the reaction by adding neutralizer and then stripping volatiles to obtain product.

“Equilibrium time” refers to the time heating is maintained after the viscosity of the reaction mixture stabilizes and ceases to change over time.

“Neutralizer” refers to a material that neutralizes the SPARC base and potassium silanolate siloxane in the reaction mixture. By neutralizing these materials, the neutralizer terminates the reaction. Examples of suitable neutralizers include silyl phosphates and carboxylic acid. One desirable neutralizer is bis(trimethylsilyl) hydrogen phosphate. The amount of neutralizer used to neutralize the reaction is usually 0.0001 wt % or more, 0.0010 wt % or more, 0.0100 wt % or more, even 0.015 wt % or more while at the same time is typically 0.09 wt % or less, 0.05 wt % or less, 0.03 wt % or less, even 0.015 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphazenium hydroxide in the process. Typically, neutralization occurs when the reaction mixture is at a temperature of zero ° C. or higher, preferably 10° C. or higher, 20° C. or higher, even 25° C. or higher while at the same time typically 30° C. or lower, even 25° C. or lower.

“Stripping volatiles” usually involves drawing a vacuum around the reaction mixture to a pressure under 95 kilopascals pressure at a temperature in a range of 150 to 155° C. to remove volatiles such as small cyclic materials. For example, stripping volatiles from a reaction mixture can occur with the reaction mixture in a flask connected to a graham condenser and then drawing a vacuum on the contents of the flask using a vacuum pump (for example, VacuuBrand, PC600 series). The stripping process continues until no further liquid comes out from the cooling column or the liquid drop rate is less than one drop in 5 seconds.

The temperature of the mixture in step (a) is typically 20° C. or higher, 25° C. or higher, 30° C. or higher, even 35° C. or higher while at the same time is typically 120° C. or lower, 100° C. or lower, 80° C. or lower, 60° C. or lower, even 40° C. or lower, and can be 35° C. or lower, 30° C. or lower, even 20° C. or lower.

Desirably, the concentration of octamethylcyclotetrasiloxane is 10 weight-percent (wt %) or more, preferably 20 wt % or more, 30 wt % or more, and can be 40 wt % or more while at the same time is typically 50 wt % or less, even 40 wt % or less based on the combined concentration of octamethylcyclotetrasiloxane, polydimethylsiloxane, tetrakis (vinyldimethylsiloxy) silane, potassium silanolate siloxane, trifluoropropy lmethylcyclotrisiloxane, and polydimethylaminophosphazenium hydroxide in the process.

Typically, the polydimethyl siloxane has a viscosity in a range of 10 to 1000 square millimeters per second (mm²/s). The degree of polymerization (“DP”, referring to the number of dimethylsiloxane units in the polymer) is typically in a range of 10 to 194. Preferably, the polydimethyl siloxane is trimethyl end-capped polydimethyl siloxane having a viscosity of approximately 10 mm²/s, such as that commercially available as DOWSIL™ 200 Fluid, 10 CST from The Dow Chemical Company (DOWSIL is a trademark of The Dow Chemical Company).

Desirably, the concentration of polydimethylsiloxane is one wt % or more and can be 2 wt % or more, even 3 wt % or more and at the same time is typically 4 wt % or less and can be 3 wt % or less, even 2 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphazenium hydroxide in the process.

Desirably, the concentration of tetrakis (vinyldimethylsiloxy) silane is one wt % or more and can be 2 wt % or more, even 3 wt % or more and at the same time is typically 4 wt % or less and can be 3 wt % or less, even 2 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphazenium hydroxide in the process.

Desirably, the concentration of potassium silanolate siloxane is 0.02 wt % or more, and can be 0.03 wt % or more, 0.04 wt % or more, 0.05 wt % or more, 0.075 wt % or more, even 0.10 wt % or more while at the same time is typically 0.12 wt % or less and can be 0.10 wt % or less, 0.09 wt % or less, 0.08 wt % or less, 0.07 wt % or less, 0.06 wt % or less, 0.05 wt % or less, or even 0.04 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphazenium hydroxide in the process.

Desirably, the concentration of trifluoropropylmethylcyclotrisiloxane is 50 wt % or more, preferably 60 wt % or more, 65 wt % or more, and can be 70 wt % or more, even 80 wt % or more while at the same time is typically 90 wt % or less, preferably 80 wt % or less, even 70 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphazenium hydroxide in the process.

Desirably, the concentration of polydimethylaminophosphazenium hydroxide is 0.0001 wt % or more, preferably 0.0002 wt % or more, 0.0003 wt % or more, 0.0004 wt % or more, 0.0005 wt % or more, and can be 0.0010 wt % or more, 0.0050 wt % or more, even 0.0075 wt % or more while at the same time is typically 0.01 wt % or less and can be 0.005 wt % or less, 0.001 wt % or less, 0.0005 wt % or less based on the combined concentration of octamethylcyclotetrasiloxane, polydimethylsiloxane, tetrakis (vinyldimethylsiloxy) silane, potassium silanolate siloxane, trifluoropropylmethylcyclotrisiloxane, and polydimethylaminophosphaz enium hydroxide in the process.

Particularly desirable processes of the present invention meet one of the following sets of conditions:
(i) The temperature of the mixture during step (a) is in a range of 20 to 25 degrees Celsius, trifluoropropylmethylcyclotrisiloxane is added to the mixture in step (a), and polydimethylaminophosphazenium hydroxide is added at a temperature in a range of 20° C. or higher, preferably 25° C. or higher, and can be added at a temperature of 30° C. or higher, 40° C. or higher, 60° C. or higher, even 80° C. or higher while at the same time is generally added at a temperature of 120° C. or lower, 100° C. or lower, 80° C. or lower, 60° C. or lower, 40° C. or lower, 30° C. or lower, or even 25° C. or lower. Preferably, trifluoropropylmethylcyclotrisiloxane is added in step (a) and step (b) is only heating. Use an equilibrium time of less than 4 hours, preferably 3 hours or less, more preferably 2 hours or less or even one hour. These conditions are particularly desirable for illustrating a shorter gel phase, a shorter equilibrium time and reduced steps with both catalysts added in one step relative to the current process for making the Target F—Si Polymer.
(ii) The temperature of the mixture during step (a) is in a range of 25 to 40 degrees Celsius and trifluoropropylmethylcyclotrisiloxane is added in step (d) and not step (a). Adding trifluoropropylmethylcyclotrisiloxane in step (d) seems to avoid a gel phase altogether during the process.
(iii) The temperature of the mixture during step (a) is in a range of 20 to 25 degrees Celsius, trifluoropropylmethylcyclotrisiloxane is added to the mixture in step (a), and polydimethylaminophosphazenium hydroxide is added at a temperature in a range of 20° C. or higher, preferably 25° C. or higher, and can be added at a temperature of 30° C. or higher, 40° C. or higher, 60° C. or higher, even 80° C. or higher while at the same time is generally added at a temperature of 120° C. or lower, 100° C. or lower, 80° C. or lower, 60° C. or lower, 40° C. or lower, 30° C. or lower, or even 25° C. or lower. The equilibrium time is less than 4 hours, preferably less than 3 hours and is typically about 2 hours or even one hour, and the temperature during neutralization in a range of zero to 30 degrees Celsius. These conditions result in a higher yield (high non-volatile content), even when using a shorter equilibrium time, than the current process for making the Target F—Si Polymer.

The process of the present invention can also benefit from using less than pure trifluoropropylmethylcyclotrisiloxane. In particular, the process can include impurities such as trifluoropropyl methyl cyclotetrasiloxane and/or cyclopentasiloxane, 2, 4, 6, 8, 10-pentamethyl-2, 4, 6, 8, 10-pentakis (3, 3, 3-trifluoropropyl) with the trifluoropropylmethylcyclotrisiloxane. For example, the process can meet the following conditions:
(iv) The temperature of the mixture during step (a) is in a range of 25 to 40 degrees Celsius (preferably about 40° C.), trifluoropropylmethylcyclotrisiloxane is added to the mixture in step (a), and trifluoropropyl methyl cyclotetrasiloxane and/or cyclopentasiloxane, 2, 4, 6, 8, 10-pentamethyl-2, 4, 6, 8, 10-pentakis (3, 3, 3-trifluoropropyl) are also present in the reaction mixture. These conditions illustrate the ability of the current process to tolerate use of “crude” trifluoropropylmethylcyc lotrisiloxane that can contain trifluoropropyl methyl cyclotetrasiloxane and/or cyclopentasiloxane, 2, 4, 6, 8, 10-pentamethyl-2, 4, 6, 8, 10-pentakis (3, 3, 3-trifluoropropyl), which allows for use of less expensive reactants than if pure trifluoropropylmethylcyclotrisiloxane was required.

### EXAMPLES

Table 1 lists the components for the following examples.

TABLE 1

| Component | Description | Source |
|---|---|---|
| D4 | Octamethylcyclotetrasiloxane | Available under the name |
| | | DOWSIL ™ 2-0408 INT from |
| | | The Dow Chemical Company. |
| F3 | trifluoropropylmethylcyclotrisiloxane | Available under the name |
| | | DOWSIL ™ 4-2900 INT from |
| | | The Dow Chemical Company. |
| PDMS 200 | Trimethyl endcapped | Available under the name |
| | polydimethylsiloxane, 10 square | DOWSIL ™ 200 Fluid, 10 CST |
| | millimeter per second viscosity | from The Dow Chemical |
| | | Company. |
| 7711 | Tetrakis(vinyldimethylsiloxy)silane | Available under the name |
| | | DOWSIL ™2-7711 INT from |
| | | The Dow Chemical Company. |
| 2812 | Potassium silanolate siloxane as a 10% | Available under the name |
| | solution in a carrier that is 96,18 wt % | DOWSIL ™ 4-2812 from The |
| | D4 and 3.77 wt % 7711. | Dow Chemical Company |
| SPARC Base | Polydimethylaminophosphazenium | Available as SPARC base from |
| | hydroxide. CAS # 569316-66-1. | Dow Corning Corporation. |
| Neutralizer | Bis(trimethylsilyl)hydrogen phosphate | Available under the name |
| | | DOWSIL ™ 4-6015 INT from |
| | | The Dow Chemical Company. |

Conduct the following processes in a 500 milliliter (mL)₄-necked round-bottomed flask with a 4-pitch blade turbine (4-PBT) impeller mixing at a speed of approximately 150 revolutions per minute.

During the processes, monitor the reaction by Raman spectroscopy using in-situ Raman process. Collect Raman spectra using an i-Raman Plus system (from BWTeck Inc., Model: BW465-785S) equipped with a 12.7 millimeter (mm) diameter short-focus Kaiser immersion optic probe. Use BWSPec4 software from BWTek Inc. and Matlab R2016a from Math Works Inc. for data processing. During the reaction, insert the Raman probe directly into the reaction mixture. Use a continuous spectrum collection mode adopted with typical acquisition conditions of 3 second exposure per scan and 5 scans for an average spectrum. The other spectral collection parameters are as follows: Laser wavelength: 784.85 nanometers; Laser level: 100%; Scan range: 115 to 3194 wavenumbers (cm⁻¹); Spectral resolution: 4 cm⁻¹; Dark subtracted: on; Time interval of spectrum collection: 10 seconds.

After quenching a process with neutralizer, determine wt % yield as determined by non-volatile content (NVC) for the resulting reaction mixture prior to isolating the product by stripping. NVC reveals the weight ratio of non-volatile polymer in a reaction mixture. Determine NVC as follows: weigh an aluminum dish (aluminum foil 50×15 mm, Sargent Welch Scientific Co., Catalog number S25725) and record the weight as “W1”. Tare the scale and add approximately 3 g of reaction mixture sample into the dish and record the actual weight of reaction mixture sample as “W2”. Place the dish containing the reaction mixture sample into a mechanical convection oven at 200° C. for 30 minutes and then place in a desiccator to cool to 25° C. Weigh and record the weight of the dish and sample and record as “W3”. Calculate NVC using: NVC=100%×(W3-W1)/W2. Measure duplicate values for each sample and take the average of the two to report as NVC for the sample.

Table 2 shows the characteristics of the processes described below and the products produced by those processes.

TABLE 2

| | | | Product Characterization | |
|---|---|---|---|---|
| | Equilibrium | Gel Time | Molecular Weight | |
| Process | Time (hours) | (minutes) | (g/mol) | NVC |
| Comparative | 4 | 70 | 15821 | 74% |
| Example A | | | | |
| Example 1 | 1 | 30 | 15335 | 75% |
| Example 2 | 1 | 0 | 14811 | 75% |
| Example 3 | 1 | 30 | 16613 | 81% |

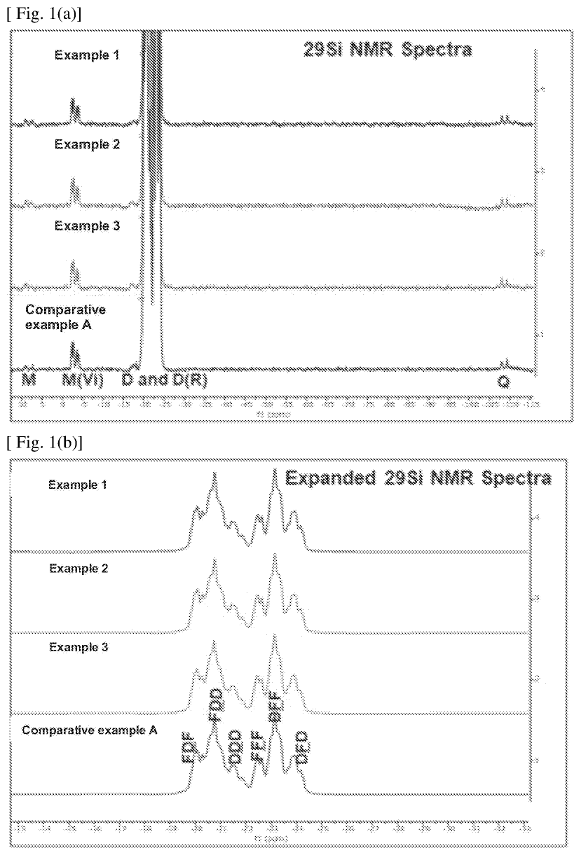

FIG. 1 (a) and FIG. 1 (b) provide silicon-29 NMR (²⁹Si NMR) spectra of the product for Comparative Example A, which is the current process, as well as Examples 1-3. FIG. 1 (b) is an enlargement of the D and D (R) peaks in the spectra in FIG. 1 (a). The NMR spectrum reveals that the product has the composition of the Target F—Si Polymer. In FIG. 1 (b), “F” refers to a methyl-3, 3, 3-trifluoropropylsiloxane unit and “D” refers to dimethylsiloxane unit. “FDF” refers to a D unit between two F units, “FDD” refers to an F unit next to two D units, “DDD” refers to three D units, “FFF” refers to three F units, “DFF” refers to D next to two F units, and “DFD” refers to an F unit between two D units.

The NMR spectra were collected with the following procedure: Prepare a 40 volume-percent sample of Comparative Example A in chloroform-d (CDCl3) in a 10 millimeter silicon-free NMR tube. Add approximately 0.02 molar chromium (III) acetylacetonate [Cr (acac)₃]. Acquire a 29Si NMR spectrum of the sample at 25° C. using a Brker 400 MHz (1H frequency) spectrometer. Use a 10 millimeter BBO silicon free switchable ¹³C/²⁹Si probe. Use inverse gated decoupling as the pulse program for quantitative 29 Si NMR. Tetramethylsilane (TMS) is used as an external reference. Set the relaxation delay at 13 seconds for 40000 scans. The pulse length is 13.5 microseconds.

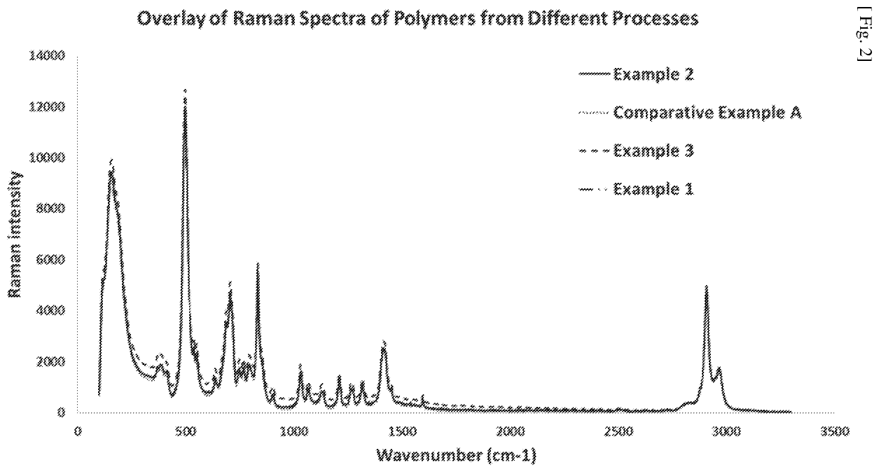

The FIG. 2 illustrates overlapping Raman spectra for the products of each of the four processes revealing that they have produced the same product. Therefore, each of Examples 1-3 product having the composition of the Target F—Si Polymer.

### Comparative Example A-Current Process

Load 108.2 grams (g) of D4, 231.3 g of F3, 6.7 g 7711 and 6.7 g of PDMS 200 into the reactor and purge with nitrogen at a flowrate of 30 mL per minute at 25° C. to remove moisture. Maintain the nitrogen purge throughout the reaction process. Heat to 40° C. Add 0.105 g of 2812 and mix with the reactants while heating to 100° C. While heating to 100° C., the Raman peak at 584 cm 1 (corresponding to F3) starts to decrease after 53° C. and then becomes flat. Maintain a temperature of 100° C. for 30 minutes and then add 3.5 microliters of SPARC base by micropipette to initiate the reaction. Increase the temperature to 145° C. using an electrical heating mantle (ZHENGZHOU Greatwall scientific industrial, Model DRT-TW, 500 mL, 350 W) and control the temperature using a temperature controller (J-KEM scientific, Model 310, with 50-500 mL). When the temperature reaches 145° C., Raman spectra begins showing product forming by means of a peak at 493 cm⁻¹. Wait until the viscosity increases and then take a sample to test viscosity using a Brookfield DV-III Ultra programmable rheometer with constant water bath at 25° C., with Spindle No. 51, torque 40-60%, 100 revolutions per minute. If the viscosity is between 270-300 mm²/s, wait for 30 minutes then retake a sample and measure viscosity. Once the viscosity remains constant for 4 hours the reaction is considered complete. Use a micropipette (BRAND 10-100 microliter) to add 53.6 microliters of neutralizer to terminate the reaction.

Strip volatiles from the reaction mixture by placing the reaction mixture into a flask connected to a graham condenser and then drawing a vacuum on the contents of the flask using a vacuum pump (for example, VacuuBrand, PC600 series). The stripping process continues until no further liquid comes out from the cooling column or the liquid drop rate is less than one drop in 5 seconds.

The final product has a weight-average molecular weight of 15,821 g/mol.

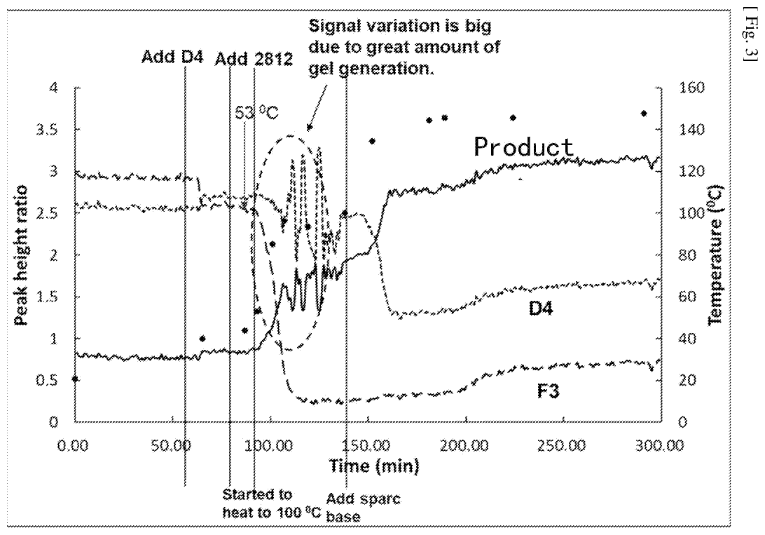

FIG. 3 provides a Raman spectral trace of the reaction versus time for Comparative Example A.

### Example 1

Load 108.2 grams (g) of D4, 231.3 g of F3, 6.7 g 7711 and 6.7 g of PDMS 200 into the reactor and purge with nitrogen at a flowrate of 30 mL per minute at 25° C. to remove moisture. Maintain the nitrogen purge throughout the reaction process. Add 0.105 g of 2812 and mix with the reactants. Add 3.5 microliters of SPARC base by micropipette to initiate the reaction at a temperature in a range of 20 to 120° C., preferably 20-25° C. Immediately a Raman peak at 584 cm⁻¹ starts to decrease until becoming flat indicating consumption of F3. Increase the temperature to 145° C. using an electrical heating mantle (ZHENGZHOU Greatwall scientific industrial, Model DRT-TW, 500 mL, 350 W) and control the temperature using a temperature controller (J-KEM scientific, Model 310, with 50-500 mL). When the temperature reaches 145° C., Raman spectra begins showing product forming by means of a peak at 493 cm⁻¹. Add 2-4 microliters of SPARC base if the peak at 493 cm 1 does not show up after the temperature has been at 145° C. for 10 minutes. Wait until the viscosity increase and then take a sample to test viscosity using a Brookfield DV-III Ultra programmable rheometer with constant water bath at 25° C., with Spindle No. 51, torque 40-60%, 100 revolutions per minute. If the viscosity is between 270-300 mm²/s, wait for 30 minutes then retake a sample and measure viscosity. Once the viscosity remains constant for one hour the reaction is considered complete (corresponding to an equilibrium time of one hour). Use a micropipette (BRAND 10-100 microliter) to add 53.6 microliters of neutralizer to terminate the reaction.

Strip volatiles from the reaction mixture by placing the reaction mixture into a flask connected to a graham condenser and then drawing a vacuum on the contents of the flask using a vacuum pump (for example, VacuuBrand, PC600 series). The stripping process continues until no further liquid comes out from the cooling column or the liquid drop rate is less than one drop in 5 seconds.

The final product has a weight-average molecular weight of 15,335 g/mol.

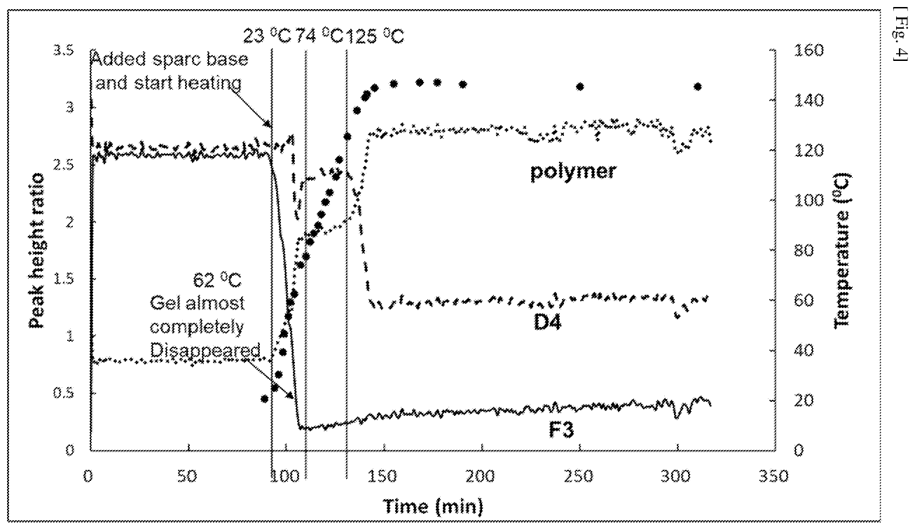

FIG. 4 provides a Raman spectral trace of the reaction versus time for Example 1. Notably, signal variation attributed to gel is nearly absent indicating much less gel formation than in Comparative Example A.

From the Raman spectra, it is evident that in the process of Example 1 the gel phase is very short, resolving a problem with the current process of Comparative Example A. When the final polymer starts to emerge at 493 cm⁻¹ and viscosity is stabilized, a one hour equilibrium time is enough and this beneficially reduces the process reducing the equilibrium time by a factor of four, reducing the batch time for our product. Also, in Example 1, both catalysts (SPARC base and 2812) are added in one step, reducing the number of steps in the process, reducing the reaction time and as noted, reducing gel formation.

### Example 2

Load 108.2 grams (g) of D4, 6.7 g 7711 and 6.7 g of PDMS 200 into the reactor and purge with nitrogen at a flowrate of 30 mL per minute at 25° C. to remove moisture. Maintain the nitrogen purge throughout the reaction process. Add 0.105 g of 2812 and mix with the reactants. Add 1.4 microliters of SPARC base by micropipette to initiate the reaction while the temperature is in a range of 25-145° C., preferably approximately 25° C. Increase the temperature to 145° C. using an electrical heating mantle (ZHENGZHOU Greatwall scientific industrial, Model DRT-TW, 500 mL, 350 W) and control the temperature using a temperature controller (J-KEM scientific, Model 310, with 50-500 mL). When the temperature reaches 90° C. the Raman spectral peak at 476 cm⁻¹ (corresponding to D4) starts to decrease and when the temperature reaches 145° C. the viscosity begins to increase. Take a sample to test viscosity using a Brookfield DV-III Ultra programmable rheometer with constant water bath at 25° C., with Spindle No. 51, torque 40-60% using 100 revolutions per minute. When the viscosity reaches 45 mm²/sadd 2.1 microliters of SPARC base and then add 231.3 g of F3 dropwise at a rate of 2.2 g per minute while at a temperature in a range of 110-150° C., preferably at 145° C. Upon completing addition of F3 increase the temperature to 145 to 150° C. Upon starting addition of F3 a Raman peak at 493 cm 1 begins to appear indicating final product formation. Continue monitoring viscosity every 30 minutes. If the viscosity is between 270-300 mm²/s, wait for 30 minutes then retake a sample and measure viscosity. Once the viscosity remains constant for one hour the reaction is considered complete (corresponding to an equilibrium time of one hour). Use a micropipette (BRAND 10-100 microliter) to add 53.6 microliters of neutralizer to terminate the reaction.

Strip volatiles from the reaction mixture by placing the reaction mixture into a flask connected to a graham condenser and then drawing a vacuum on the contents of the flask using a vacuum pump (for example, VacuuBrand, PC600 series). The stripping process continues until no further liquid comes out from the cooling column or the liquid drop rate is less than one drop in 5 seconds.

The final product has a weight-average molecular weight of 14811 g/mol.

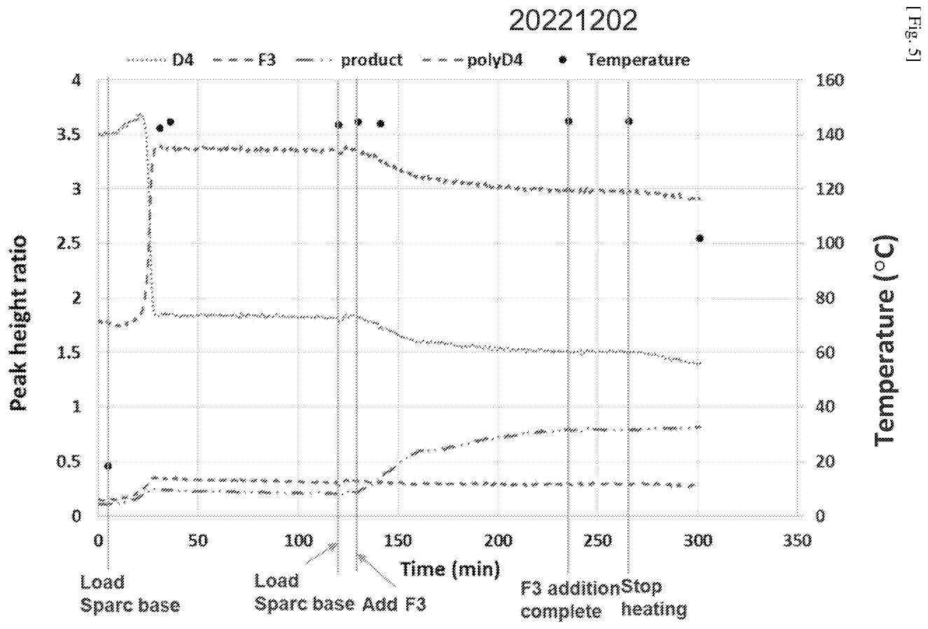

FIG. 5 provides a Raman spectral trace of the reaction versus time for Example 2. Notably, signal variation attributed to gel is entirely absent indicating no gel formation, in contrast to Comparative Example A. “Poly D4” refers to polymerized homopolymer of D4. Notably, the equilibrium time is also a factor of four less than that of the Current Process illustrated by Comparative Example A.

### Example 3

Load 108.2 grams (g) of D4, 231.28 g of F3, 6.7 g 7711 and 6.7 g of PDMS 200 into the reactor and purge with nitrogen at a flowrate of 30 mL per minute at 25° C. to remove moisture. Maintain the nitrogen purge throughout the reaction process. Add 0.105 g of 2812 and mix with the reactants. Add 3.5 microliters of SPARC base by micropipette to initiate the reaction at a temperature in a range between 2° and 120° C., preferably approximately 25° C. Increase the heating temperature to 145° C. Add 2 to 4 microliters of SPARC base if a peak at 493 cm⁻¹ does not show up in a Raman spectrum after the temperature is at 145° C. for 10 minutes. When the temperature reaches 145° C. and the viscosity begins to increase take a sample to test viscosity using a Brookfield DV-III Ultra programmable rheometer with constant water bath at 25° C., with Spindle No. 51, torque 40-60%, 100 revolutions per minute. If the viscosity is between 270-300 mm²/s, wait for 30 minutes then retake a sample and measure viscosity. Once the viscosity remains constant for one hour (corresponding to an equilibrium time of one hour), decrease the temperature to a temperature in a range of zero to 30° C., preferably approximately 30° C. and the viscosity will increase to 340-360 mm²/s. Then use a micropipette (BRAND 10-100 microliter) to add 53.6 microliters of neutralizer to terminate the reaction.

Strip volatiles from the reaction mixture by placing the reaction mixture into a flask connected to a graham condenser and then drawing a vacuum on the contents of the flask using a vacuum pump (for example, VacuuBrand, PC600 series). The stripping process continues until no further liquid comes out from the cooling column or the liquid drop rate is less than one drop in 5 seconds.

The final product has a weight-average molecular weight of 16,613 g/mol.

Example 3 illustrates that neutralizing at a lower temperature tends to increase yield while also reducing the equilibrium time by a factor of four relative to the current process of Comparative Example A.

1. A process for preparing a fluoro-silicon polymer where the process comprises the following steps:
(a) combining together the following components to form a mixture:
i. octamethylcyclotetrasiloxane;
ii. polydimethylsiloxane;
iii. tetrakis (vinyldimethylsiloxy) silane;
iv. potassium silanolate siloxane; and
v. optionally, trifluoropropylmethylcyclotrisiloxane;
(b) adding to the mixture polydimethylaminophosphazenium hydroxide to form a reaction mixture and then heating the reaction mixture to a temperature in a range of 140 to 150 degrees Celsius;
(c) if trifluoropropylmethylcyclotrisiloxane was not added in step (a), adding it dropwise to the reaction mixture while the reaction mixture is at a temperature in a range of 110 to 150 degrees Celsius until the trifluoropropylmethylcyclotrisiloxane ceases to be consumed or until a desired amount has been added;
(d) maintaining the reaction mixture at a temperature in a range of 140 to 150 degrees Celsius as the viscosity of the reaction mixture increases and for an equilibrium time in a range of one to 4 additional hours after the reaction mixture viscosity stabilizes; and
(e) terminating the reaction by adding a neutralizer and then stripping volatiles to obtain product.

2. The process of claim 1, wherein the concentration of each component is as follows:
(a) octamethylcyclotetrasiloxane is in a range of 10 to 50 weight-percent;
(b) polydimethylsiloxane is in a range of one to 4 weight-percent;
(c) tetrakis (vinyldimethylsiloxy) silane is in a range of one to 4 weight-percent;
(d) potassium silanolate siloxane is in a range of 0.02 to 0.12 weight-percent;
(e) trifluoropropylmethylcyclotrisiloxane is in a range of 50 to 90 weight-percent; and
(f) polydimethylaminophosphazenium hydroxide is 0.0001 to 0.01 weight-percent;
wherein weight-percent values are based on the combined concentration of octamethylcyclotetrasiloxane, polydimethylsiloxane,
tetrakis (vinyldimethylsiloxy) silane, potassium silanolate siloxane, trifluoropropylmethylcyclotrisiloxane, and polydimethylaminophosphazenium hydroxide in the process.

3. The process of claim 1, wherein the temperature of the mixture in step (a) is in a range of 20 to 40 degrees Celsius.

4. The process of as claim 1, wherein the reaction mixture temperature during neutralization is in a range of zero to 30 degrees Celsius.

5. The process of claim 1, wherein one of the following sets of conditions is met:
i. the temperature of the mixture during step (a) is in a range of 20 to 25 degrees Celsius, trifluoropropylmethylcyclotrisiloxane is added to the mixture in step (a), polydimethylaminophosphazeium hydroxide is added at a temperature in a range of 20 to 25° C., and use an equilibrium time of less than 4 hours;
ii. the temperature of the mixture during step (a) is in a range of 25 to 40 degrees Celsius and trifluoropropylmethylcyclotrisiloxane is added in step (c) and not step (a); and
iii. the temperature of the mixture during step (a) is in a range of 20 to 25 degrees Celsius, trifluoropropylmethylcyclotrisiloxane is added to the mixture in step (a), the equilibrium time is less than 4 hours, and the temperature during neutralization in a range of zero to 30 degrees Celsius.
